(19) United States
(12) Patent Application Publication
(10) Pub. No.: US 2022/0100780 A1
(43) Pub. Date: Mar. 31, 2022

(54) METHODS AND SYSTEMS FOR DETERMINISTIC CLASSIFICATION OF LOG MESSAGES

(71) Applicant: WMWARE, INC., Palo Alto, CA (US)

(72) Inventors: CHANDRASHEKHAR JHA, Bangalore (IN); SIDDARTHA LAXMAN LK, Bangalore (IN); YASH BHATNAGAR, Bangalore (IN); RITESH JHA, Bangalore (IN); RUPASHREE HEGGADADEVANAKOTE RANGAIYENGAR, Mysuru (IN)

(21) Appl. No.: 17/100,766

(22) Filed: Nov. 20, 2020

(30) Foreign Application Priority Data
Sep. 25, 2020 (IN) 202041041793

(51) Int. Cl. G06F 16/28; G06F 16/22

(52) U.S. Cl. CPC G06F 16/285; G06F 16/2255

(57) ABSTRACT

Methods and systems described herein are directed to classifying log messages generated by event sources of a distributed computing systems. Methods and systems generate a Grok expression and determine log-message metadata for each log message generated by the event sources. For each log message, the log message is classified based on the corresponding Grok expression and log-message metadata. Classified log messages may be used to perform troubleshooting and root cause analysis of the event sources.

### RELATED APPLICATIONS

Benefit is claimed under 35 U.S.C. 119(a)-(d) to Foreign Application Serial No. 202041041793 filed in India entitled “METHODS AND SYSTEMS FOR DETERMINISTIC CLASSIFICATION OF LOG MESSAGES”, on Sep. 25, 2020, by VMware, Inc., which is herein incorporated in its entirety by reference for all purposes.

### TECHNICAL FIELD

This disclosure is directed to classifying log messages.

### BACKGROUND

Data centers execute thousands of applications that enable businesses, governments, and other organizations to offer services over the Internet. These organizations cannot afford problems that result in downtime or slow performance of their applications. Performance issues can frustrate users, damage a brand name, result in lost revenue, and deny people access to vital services. In order to aid system administrators and application owners with detection of problems, various management tools have been developed to collect performance information about applications, services, and hardware. A typical log management tool, for example, records log messages generated by various operating systems and applications executing in a data center. Each log message is an unstructured or semi-structured time-stamped message that records information about the state of an operating system, state of an application, state of a service, or state of computer hardware at a point in time. Most log messages record benign events, such as input/output operations, client requests, logins, logouts, and statistical information about the execution of applications, operating systems, computer systems, and other devices of a data center. For example, a web server executing on a computer system generates a stream of log messages, each of which describes a date and time of a client request, web address requested by the client, and IP address of the client. Other log messages record diagnostic information, such as alarms, warnings, errors, or emergencies.

System administrators and application owners use log messages to perform root cause analysis (“RCA”) of problems, perform troubleshooting, and monitor execution of applications, operating systems, computer systems, and other devices of the data center. With the increasing number of organizations offering services over the Internet, the rate at which log messages are generated is increasing and is becoming more challenging for system administrators and application owners to view the multitude of different types of log messages. For example, an application executing in a data center may generate millions of log messages per minute with only a small fraction that may be used to determine a root cause of a problem. Log management tools have been developed to aid system administrators and application owners manage the extremely large numbers of log messages. These management tools use filters that enable a user to examine specific logs of interest. However, even after filtering, the log messages that pass the filters can be in the millions which remains challenging for a user to get an overview of the various different types of log messages.

In an effort to reduce the number of log messages, many log management tools classify log messages based on patterns of parametric and non-parametric terms. For example, a web server may receive millions of client requests for a particular service each day. Each request may be recorded in a separate log message. The only differences between these log messages are the time stamps and parameters identifying the clients, such as each client's IP address. The body of log messages that describe client requests may be a class. By presenting an administrator or application owner with classes of log messages, the number of different log messages viewed by the administrator or application owner is significantly reduced. However, typical log management tools have a log classification accuracy rate of about 70-80%, leaving about 20-30% of log messages unclassified. In order to accurately evaluate classified log messages for log message ranking, discovery of event trends, trouble shooting, and RCA, log message classification should be closer to a 100% accuracy rate. System administrators and application owners seek methods and systems that accurately reduce the vast numbers of log messages in order to perform trouble shooting and RCA.

### SUMMARY

Methods and systems described herein are directed to deterministic classification of log messages generated by event sources of a distributed computing systems. In one aspect, a method stored in one or more data-storage devices and executed using one or more processors of a computer system generates a (Grok expression for each log message generated by the event sources. The method also determines log-message metadata for each of the log messages. The log-message metadata may include one or more of counts of strings, counts of integers, counts of metrics, and counts of characters. For each log message, the log message is classified based on the corresponding Grok expression and log-message metadata. Representatives of each class of log message may be displayed in a graphical user interface. Classified log messages may also be used to perform troubleshooting and root cause analysis of the event sources.

### DESCRIPTION OF THE DRAWINGS

FIG. 1 shows an example of logging log messages in log files.

FIG. 2 shows an example source code of an event source.

FIG. 3 shows an example of a log write instruction.

FIG. 4 shows an example of a log message generated by the log write instruction in FIG. 3.

FIG. 5 shows a small, eight-entry portion of a log file.

FIGS. 6A-6C show an example of the log management server receiving log messages from event sources.

FIG. 7 shows an overview of deterministic classification of log messages and tagging of log messages that belong to the same class.

FIGS. 8A-8B show screen shots of a graphical user interface that displays representative log messages of five different classes of log messages.

FIG. 9 shows a table of examples of primary Grok patterns and corresponding regular expressions.

FIG. 10 shows a table of examples of composite Grok patterns.

FIGS. 11A-11B show an example of parsing a log message with a Grok expression.

FIG. 12 shows an example of a hash code generator that receives as input a Grok expression and outputs a hash code.

FIG. 13A shows an example of generating a hash code 1302 from a Grok expression of an example log message using the ASCII numerical encoding shown in FIG. 13B.

FIG. 14 shows an example of a collision.

FIG. 15A shows an example of determining log-message metadata from the log message 1104 in FIG. 11.

FIG. 15B shows an example of log-message metadata of the log message 1104.

FIG. 16 shows an example hash table entry for the log message 1104 in a hash table 1602.

FIG. 17 shows an example entry of a log file 1702 with the log message 1104 tagged with the tag 1610.

FIGS. 18A-18B show an example of adding log-message metadata to a hash table entry of a hash table as a result of a hash code collision.

FIG. 19 is a flow diagram deterministic classification of log messages.

FIG. 20 is a flow diagram illustrating an example implementation of the “determine log-message metadata of the log message” procedure performed in FIG. 19.

FIG. 21 is a flow diagram illustrating an example implementation of the “generate a hash code, “hash.code” from the Grok expression procedure” procedure performed in FIG. 19.

FIG. 22 is a flow diagram illustrating an example implementation of the “determine if the hash code is in a hash table entry of a hash table” procedure performed in FIG. 19.

FIG. 23 is a flow diagram illustrating an example implementation of the “generate a new hash table entry with the hash code and the log-message metadata” procedure performed in FIG. 19.

FIG. 24 is a flow diagram illustrating an example implementation of the “determine whether log-message metadata of the log message matches log-message metadata recorded in the hash table entry” procedure performed in FIG. 19.

FIG. 25 is a flow diagram illustrating an example implementation of the “adjust the hash table entry” procedure performed in FIG. 19.

FIG. 26 shows an example of a computer system that executes operations performed by a log management server.

### DETAILED DESCRIPTION

This disclosure is directed to deterministic classification of log messages. Log messages and log files are described below in a first subsection. An example of a log management server executed in a distributed computing system is described below in a second subsection. Methods and systems for deterministic classification of log messages are described below in a third subsection.

Log Messages and Log Files

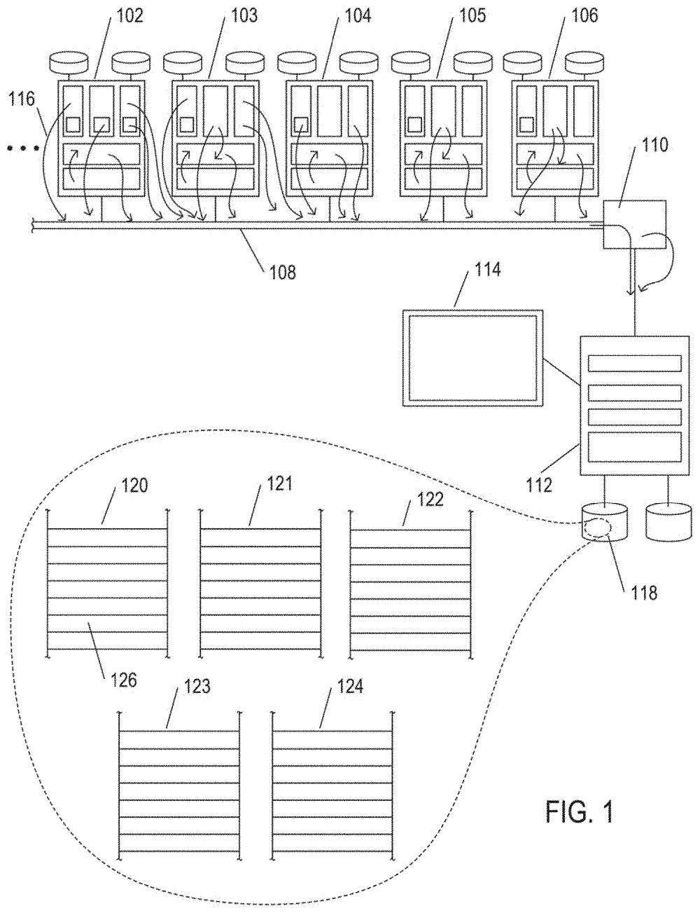

FIG. 1 shows an example of logging log messages in log files. In FIG. 1, computer systems 102-106 within a distributed computing system, such as data center, are linked together by an electronic communications medium 108 and additionally linked through a communications bridge/router 110 to an administration computer system 112 that includes an administrative console 114 and executes a log management server described below. Each of the computer systems 102-106 may run a log monitoring agent that forwards log messages to the log management server executing on the administration computer system 112. As indicated by curved arrows, such as curved arrow 116, multiple components within each of the discrete computer systems 102-106 as well as the communications bridge/router 110 generate log messages that are forwarded to the log management server. Log messages may be generated by any event source. Event sources may be, but are not limited to, application programs, operating systems. VMs, guest operating systems, containers, network devices, machine codes, event channels, and other computer programs or processes running on the computer systems 102-106, the bridge/router 110 and any other components of a data center. Log messages may be received by log monitoring agents at various hierarchical levels within a discrete computer system and then forwarded to the log management server executing in the administration computer system 112. The log management server records the log messages in a data-storage device or appliance 118 as log files 120-124. Rectangles, such as rectangle 126, represent individual log messages. For example, log file 120 may contain a list of log messages generated within the computer system 102. Each log monitoring agent has a configuration that includes a log path and a log parser. The log path specifies a unique file system path in terms of a directory tree hierarchy that identifies the storage location of a log file on the administration computer system 112 or the data-storage device 118. The log monitoring agent receives specific file and event channel log paths to monitor log files and the log parser includes log parsing rules to extract and format lines of the log message into log message fields described below. Each log monitoring agent sends a constructed structured log message to the log management server. The administration computer system 112 and computer systems 102-106 may function without log monitoring agents and a log management server, but with less precision and certainty.

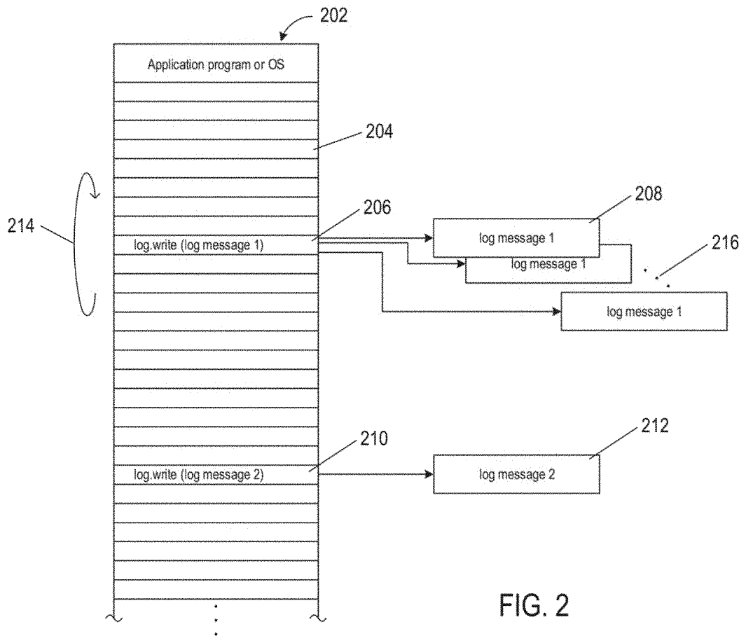

FIG. 2 shows an example source code 202 of an event source, such as an application, an operating system, a VM, a guest operating system, or any other computer program or machine code that generates log messages. The source code 202 is just one example of an event source that generates log messages. Rectangles, such as rectangle 204, represent a definition, a comment, a statement, or a computer instruction that expresses some action to be executed by a computer. The source code 202 includes log write instructions that generate log messages when certain events predetermined by a developer occur during execution of the source code 202. For example, source code 202 includes an example log write instruction 206 that when executed generates a “log message 1” represented by rectangle 208, and a second example log write instruction 210 that when executed generates “log message 2” represented by rectangle 212. In the example of FIG. 2, the log write instruction 208 is embedded within a set of computer instructions that are repeatedly executed in a loop 214. As shown in FIG. 2, the same log message 1 is repeatedly generated 216. The same type of log write instructions may also be located in different places throughout the source code, which in turns creates repeats of essentially the same type of log message in the log file.

In FIG. 2, the notation “log.write( )” is a general representation of a log write instruction. In practice, the form of the log write instruction varies for different programming languages. In general, the log write instructions are determined by the developer and are unstructured, or semi-structured, and in many cases are relatively cryptic. For example, log write instructions may include instructions for time stamping the log message and contain a message comprising natural-language words and/or phrases as well as various types of text strings that represent file names, path names, and, perhaps various alphanumeric parameters that may identify objects, such as VMs, containers, or virtual network interfaces. In practice, a log write instruction may also include the name of the source of the log message (e.g., name of the application program, operating system and version, server computer, and network device) and may include the name of the log file to which the log message is recorded. Log write instructions may be written in a source code by the developer of an application program or operating system in order to record the state of the application program or operating system at point in time and to record events that occur while an operating system or application program is executing. For example, a developer may include log write instructions that record informative events including, but are not limited to, identifying startups, shutdowns, I/O operations of applications or devices; errors identifying runtime deviations from normal behavior or unexpected conditions of applications or non-responsive devices; fatal events identifying severe conditions that cause premature termination; and warnings that indicate undesirable or unexpected behaviors that do not rise to the level of errors or fatal events. Problem-related log messages (i.e., log messages indicative of a problem) can be warning log messages, error log messages, and fatal log messages. Informative log messages are indicative of a normal or benign state of an event source.

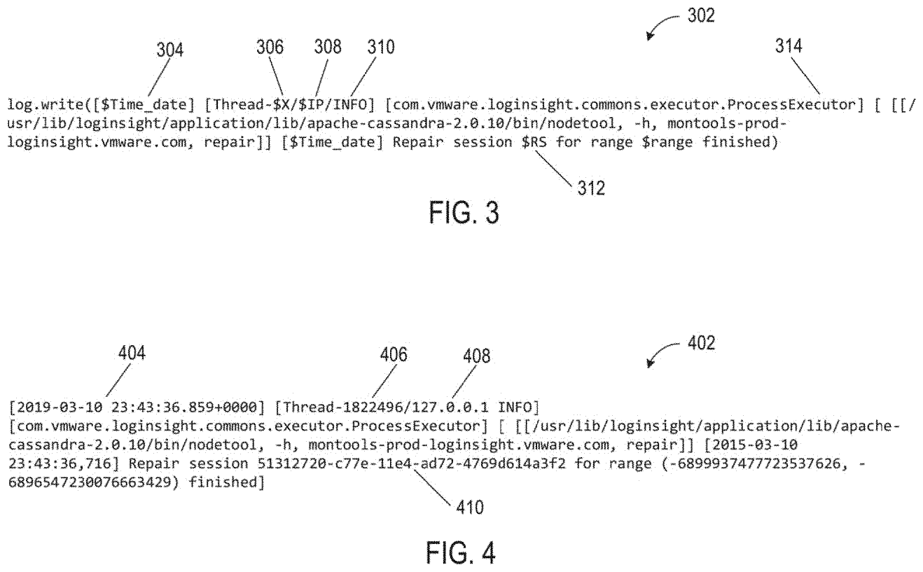

FIG. 3 shows an example of a log write instruction 302. The log write instruction 302 includes arguments identified with “S” that are filled at the time the log message is created. For example, the log write instruction 302 includes a time-stamp argument 304, a thread number argument 306, and an internet protocol (“IP”) address argument 308. The example log write instruction 302 also includes text strings and natural-language words and phrases that identify the level of importance of the log message 310 and type of event that triggered the log write instruction, such as “Repair session” argument 312. The text strings between brackets “[ ]” represent file-system paths, such as path 314. When the log write instruction 302 is executed by a log management agent, parameters are assigned to the arguments and the text strings and natural-language words and phrases are stored as a log message of a log file.

FIG. 4 shows an example of a log message 402 generated by the log write instruction 302. The arguments of the log write instruction 302 may be assigned numerical parameters that are recorded in the log message 402 at the time the log message is executed by the log management agent. For example, the time stamp 304, thread 306, and IP address 308 arguments of the log write instruction 302 are assigned corresponding numerical parameters 404, 406, and 408 in the log message 402. Alphanumeric expression 410 is assigned to a repair session argument 312. The time stamp 404 represents the date and time the log message 402 is generated. The text strings and natural-language words and phrases of the log write instruction 302 also appear unchanged in the log message 402 and may be used to identify the type of event (e.g., informative, warning, error, or fatal) that occurred during execution of the event source.

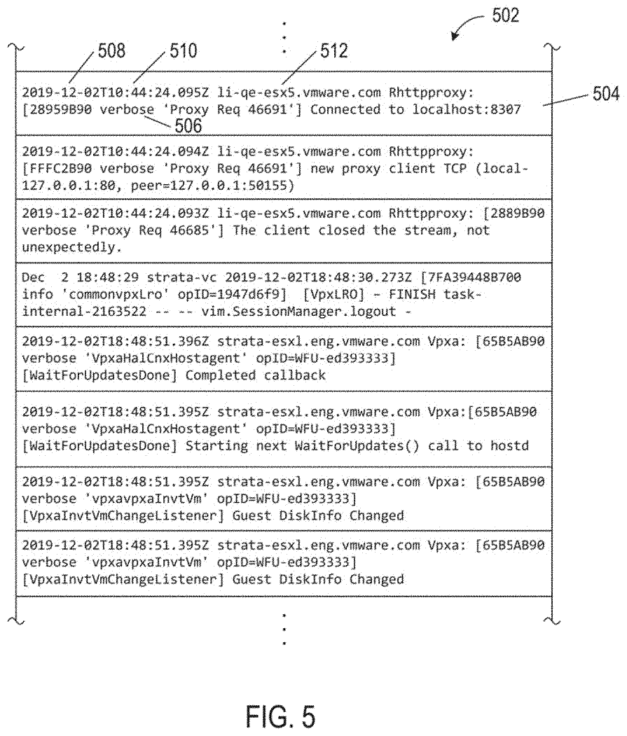

As log messages are received from various event sources, the log messages are stored in corresponding log files in the order in which the log messages are received. FIG. 5 shows a small, eight-entry portion of a log file 502. In FIG. 5, each rectangular cell, such as rectangular cell 504, of the log file 502 represents a single stored log message. For example, log message 504 includes a short natural-language phrase 506, date 508 and time 510 numerical parameters, and an alphanumeric parameter 512 that identifies a particular host computer.

Log Management Server

In large, distributed computing systems, such as a data center, terabytes of log messages may be generated each day. The log messages may be sent to a log management server that records the log messages in log files that are in turn stored in data-storage appliances.

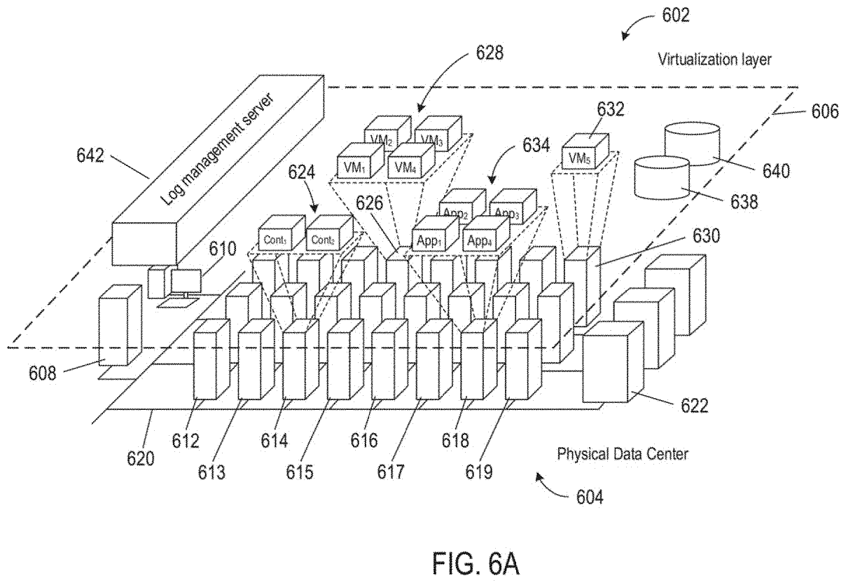

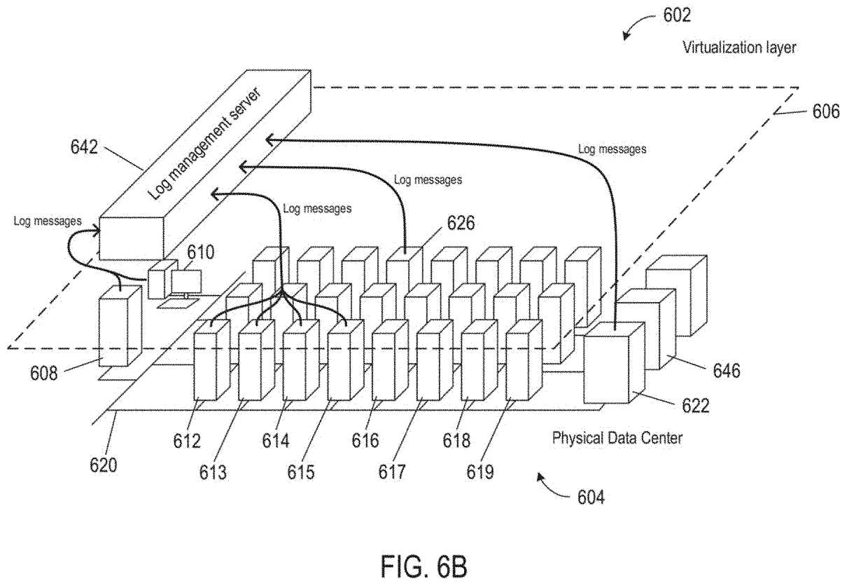

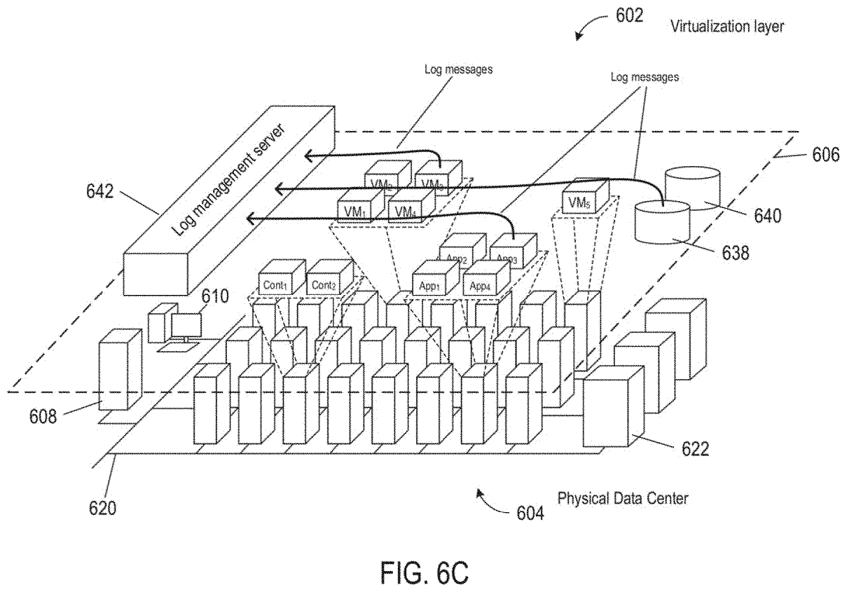

FIG. 6A shows an example of a virtualization layer 602 located above a physical data center 604. For the sake of illustration, the virtualization layer 602 is separated from the physical data center 604 by a virtual-interface plane 606. The physical data center 604 is an example of a distributed computing system. The physical data center 604 comprises physical objects, including an administration computer system 608, any of various computers, such as PC 610, on which a virtual-data-center (“VDC”) management interface may be displayed to system administrators and other users, server computers, such as server computers 612-619, data-storage devices, and network devices. The server computers may be networked together to form networks within the data center 604. The example physical data center 604 includes three networks that each directly interconnects a bank of eight server computers and a mass-storage array. For example, network 620 interconnects server computers 612-619 and a mass-storage array 622. Different physical data centers may include many different types of computers, networks, data-storage systems and devices connected according to many different types of connection topologies. The virtualization layer 602 includes virtual objects, such as VMs, applications, and containers, hosted by the server computers in the physical data center 604. The virtualization layer 602 may also include a virtual network (not illustrated) of virtual switches, routers, load balancers, and network interface cards formed from the physical switches, routers, and network interface cards of the physical data center 604. Certain server computers host VMs and containers as described above. For example, server computer 614 hosts two containers 624, server computer 626 hosts four VMs 628, and server computer 630 hosts a VM 632. Other server computers may host applications as described above with reference to FIG. 4. For example, server computer 618 hosts four applications 634. The virtual-interface plane 606 abstracts the resources of the physical data center 604 to one or more VDCs comprising the virtual objects and one or more virtual data stores, such as virtual data stores 638 and 640. For example, one VDC may comprise VMs 628 and virtual data store 638. Automated methods and systems described herein may be executed by a log management server 642 implemented in one or more VMs on the administration computer system 608. The log management server 642 receives log messages generated by event sources and records the log messages in log tiles as described below.

FIGS. 6B-6C show the example log management server 642 receiving log messages from event sources. Directional arrows represent log messages sent to the log management server 642. In FIG. 6B, operating systems and applications running on PC 610, server computers 608 and 644, network devices, and mass-storage array 646 send log messages to the log management server 642. Operating systems and applications running on clusters of server computers may also send log messages to the log management server 642. For example, a cluster of server computers 612-615 sends log messages to the log management server 642. In FIG. 6C, guest operating systems, VMs, containers, applications, and virtual storage may independently send log messages to the log management server 642.

Deterministic Classification of Log Messages

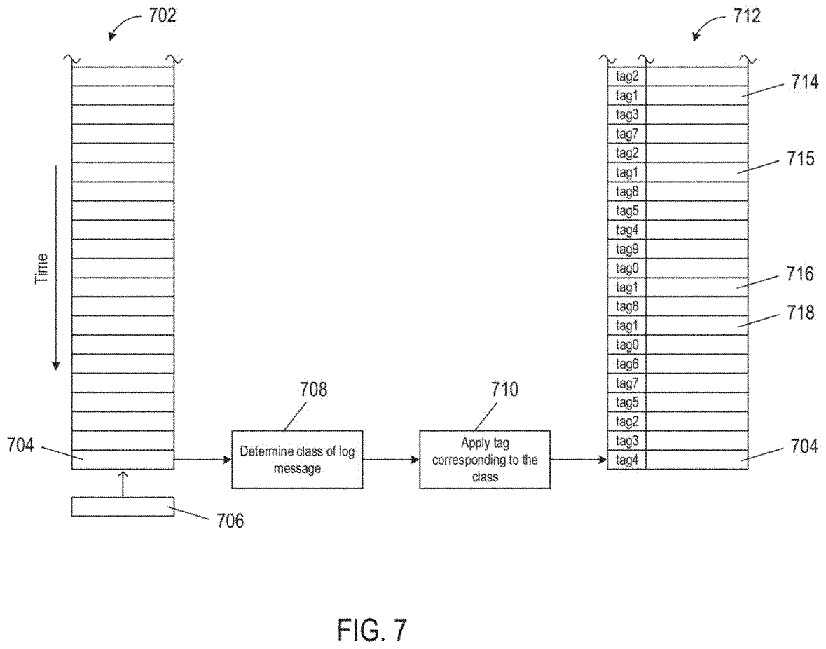

Methods and systems described herein are directed to deterministic classification of log messages. FIG. 7 shows an overview of deterministic classification of log messages and tagging of log messages that belong to the same class. Stack of rectangles 702 represents a stream of log messages received by the log management server 642. Each rectangle, such as rectangle 704, represents a separate log message generated by an event source. Rectangle 706 represents a most recently generated log message received by the log management server 642 to be added to the stream 702. Each log message received by the log management server 642 is classified and tagged according to the structure or form of the log message. Block 708 represents a process of classifying each log message added to the stream of log messages 702. Block 710 represents a process of tagging each classified log message with a tag that identifies the class the log message belongs to. A detailed description of the operations performed in blocks 708 and 710 is provided below. In the example of FIG. 7, a log file 712 comprises the same log messages 702 with each log message assigned one of ten example tags denoted by tagN, where an index N=0, 1, . . . , 9 is used to distinguish the tags. It should be noted that in practice the classes the log messages are identified as belonging to in block 708 are not defined in advance by a system administrator, an application owner, or a user. In block 708, the classes are determined by the structure or form of the log messages and is not based on the subject matter described in the log messages. In block 710, a tag is determined for each class and applied to log messages that belong to the same class. For example, log message 704 has been classified in block 708 and tagged with “tag4” in block 710 and added to the log file 712. Log messages 714-718 were separately identified as belonging to the same class in block 708 and tagged in block 710 with the same tag “tag1” to identify the class. When the recently received log message 706 is evaluated in block 708, it may be determined in block 708 that the log message 706 belongs to one of the already existing classes denoted by tagN, where N=0, 1, . . . , 9. The log message 706 is tagged with one of the tags already used to classify log messages in the same class. Alternatively, it may be determined in block 708 that the log message 706 belongs to an entirely different class, in which case the process represented by block 708 creates a new classification for the log message 706. In block 710, a new tag, such as tag10, is generated for the log message 706 and the log message 706 is added to the log file 712 with the tag, tag10.

In order to reduce the number of log messages presented to a user, such as a system administrator or an application owner, the user may view representative log messages of each of the identified classes in a graphical-user interface (“GUI”). The representative log message of each class may be the most recently generated log message that belongs to the class. For example, the log message 718 is the most recently generated log message in the class of log messages 714-718 and may be displayed in a GUI as a representative log message of the class of log messages 714-718.

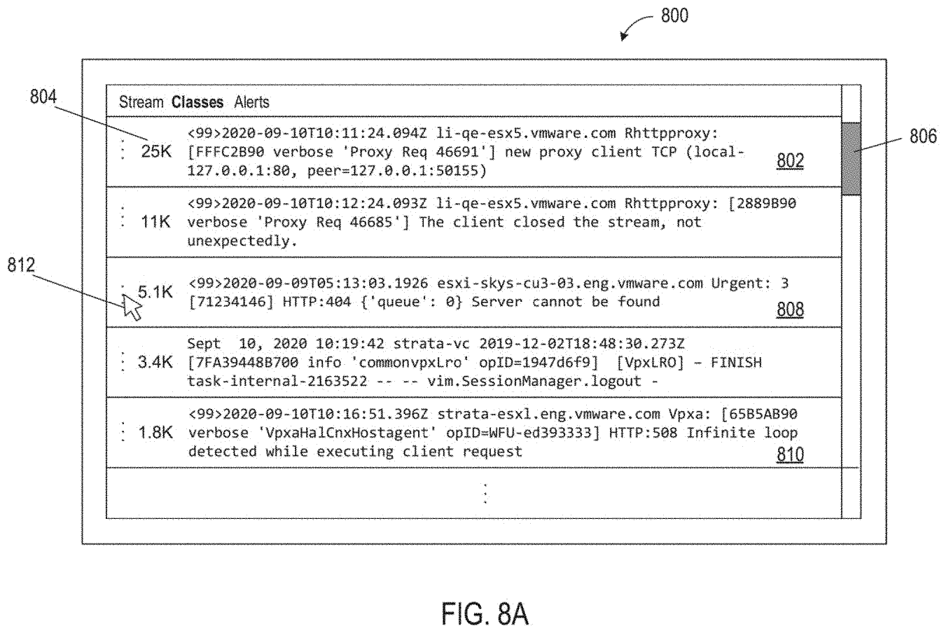

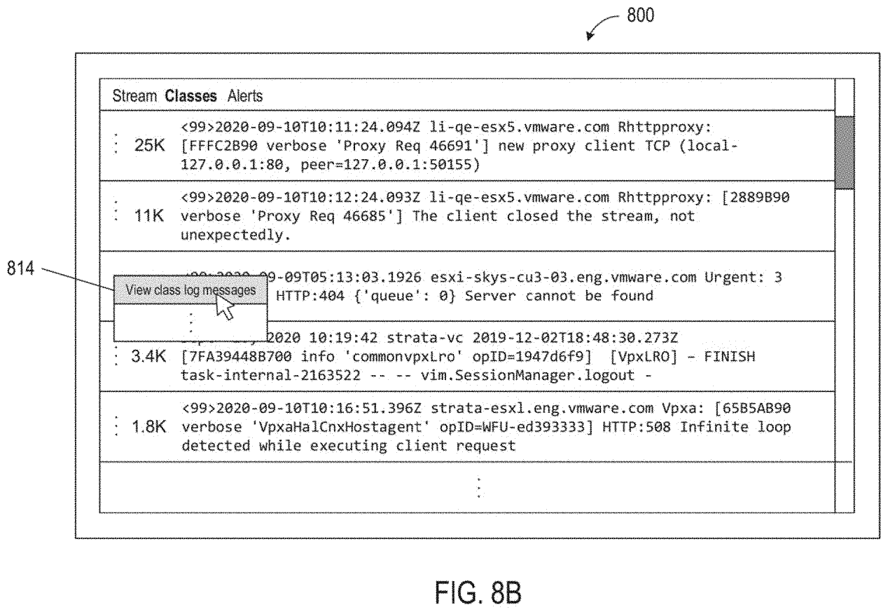

FIGS. 8A-8B show screen shots of a GUI 800 that displays representative log messages of five different classes of log messages. In FIG. 8A, entry 802 displays the most recently generated log messages that belongs to one of the five different classes shown. Each entry includes a counter of the number of log messages that belong to the same class. For example, counter 804 in the entry 802 indicates that the class comprises at least 25,000 log messages. Note GUI 800 includes a scroll bar 806 that enables a user to scroll through and read only the representative log messages of each class in order to spot log messages that may be of interest. For example, entry 808 includes an HTTP code 404 that indicates a server cannot be found. Entry 810 includes an HTTP code 508 that indicates a client request has entered an infinite loop and therefore cannot be processed. The user may also be able to click on a menu icon 812 to request a listing of all log messages 814 belonging to the same the class, as shown in FIG. 8B.

Methods and systems for deterministic classification and tagging of various types of log messages are described below. The log management server 642 creates a Grok expression for each log message received by the log management server 642 and uses the Grok expression to classify the log message as described below.

Grok Patterns and Grok Expressions

Methods and systems automatically determine a Grok expression for each log message received by the log management server 642. A grok expression is a language parsing expression that may be used to extract strings and parameters from log messages that match the Grok expression. Grok expressions are formed from Grok patterns, which are in turn representations of regular expressions. A regular expression, also called “regex” is a sequence of symbols that defines a search pattern in text data. Regular expressions are specifically designed to match a particular string of characters in log messages and can be become lengthy and extremely complex. For example, because log messages are unstructured, different types of regular expressions are configured to match various different character strings used to record a date and time in the time stamp portion of a log message. Grok patterns are predefined symbolic representations of regular expressions that reduce the complexity of manually constructing regular expressions. Grok patterns may be categorized as either primary Grok patterns or composite Grok patterns that are formed from primary Grok patterns. A Grok pattern is called and executed using Grok syntax notation denoted by %{Grok pattern}. Methods and system for automated determination of Grok expressions from log messages are described in U.S. patent application Ser. No. 17/008,755, filed Sep. 1, 2020, owned by VMware Inc, and is herein incorporated by reference.

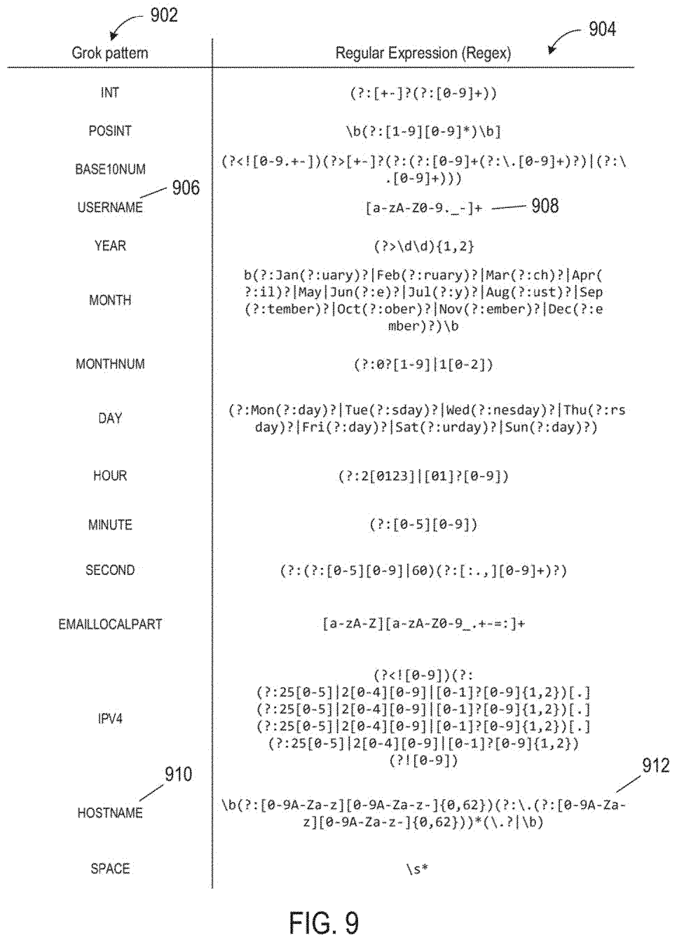

FIG. 9 shows a table of examples of primary Grok patterns and corresponding regular expressions. Column 902 contains a list of primary Grok patterns. Column 904 contains a list of regular expressions represented by the Grok patterns in column 902. For example, the Grok pattern “USERNAME” 906 represents the regex 908 that matches one or more occurrences of a lower-case letter, an upper-case letter, a number between 0 and 9, a period, an underscore, and a hyphen in a character string. Grok pattern “HOSTNAME” 910 represents the regex 912 that matches a hostname. A hostname comprises a sequence of labels that are concatenated with periods. Note that the list of primary Grok patterns shown in FIG. 9 is not an exhaustive list of primary Grok patterns.

A composite Grok pattern comprises two or more primary Grok patterns. Composite Grok patterns may also be formed from combinations of composite Grok patterns and combinations of composite Grok patterns and primary (Grok patterns.

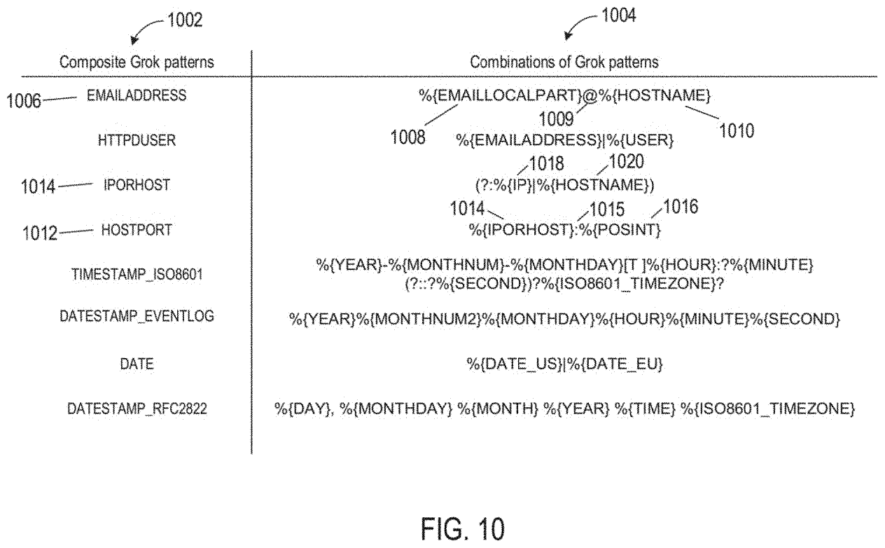

FIG. 10 shows a table of examples of composite Grok patterns. Column 1002 contains a list of composite Grok patterns. Column 1004 contains a list of composite Grok patterns that are represented by the Grok patterns in column 802. For example, composite Grok pattern “EMAILADDRESS” 1006 comprises a combination of “EMAILLOCALPART” 1008, an ampersand 1009, and “HOSTNAME” 1010. The Grok patterns “EMAILLOCALPART” 1008 and “HOSTNAME” 1010 are primary Grok patterns listed in the table shown in FIG. 9. The composite Grok pattern “EMAILADDRESS” 1006 matches the format of nearly any email address. Composite Grok pattern “HOSTPORT” 812 is a combination of a composite Grok pattern “IPORHOST” 1014, a colon 1015, and a primary Grok pattern “POSINT” 1016. The composite Grok pattern “IPORHOST” 1014 is a composite Grok pattern formed from primary Grok pattern “IP” 1018 and primary Grok pattern “HOSTNAME” 1020. Note that the list of composite Grok patterns shown in FIG. 10 is not an exhaustive list of composite Grok patterns.

Composite Grok patterns also include user defined Grok patterns, such as composite Grok patterns defined by a user. User defined Grok patterns may be formed from any combination of composite and/or primary Grok patterns. For example, a user may define a Grok pattern MYCUSTOMPATTERN as the combination of Grok patterns %{TIMESTAMP_ISO8601} and %{HOSTNAME}, where TIMESTAMP_ISO8601 is a composite Grok pattern listed in the table of FIG. 10 and HOSTNAME is a primary Grok pattern listed in the table of FIG. 9.

Grok patterns may be used to map specific character strings into dedicated variable identifiers. Grok syntax for using a Grok pattern to map a character string to a variable identifier is given by:
%{GROK_PAFERN:variable_name}

where
GROK_PATTERN represents a Grok pattern; and
variable_name is a variable identifier assigned to a character string in text data that matches the GROK_PATTERN.
   A Grok expression is a parsing expression that is constructed from Grok patterns that match characters strings in text data and may be used to parse character strings of a log message. Consider, for example, the following simple example segment of a log message:
34.5.243.1 GET index.html 14763 0.064
   A Grok expression that may be used to parse the example segment is given by:
\hat{ }%{IP:ip_address}\s%{WORD:word}\s%{URIPATHPARAM:request}\s
%{INT:bytes}\s%{NUMBER:duration}$
   The hat symbol “\hat{ }” identifies the beginning of a Grok expression. The dollar sign symbol “$” identifies the end of a Grok expression. The symbol “\s” matches spaces between character strings in the log message. The Grok expression parses the example segment by assigning the character strings of the log message to the variable identifiers of the Grok expression as follows:
ip_address: 34.5.243.1
word: GET
request: index.html
bytes: 14763
duration: 0.064

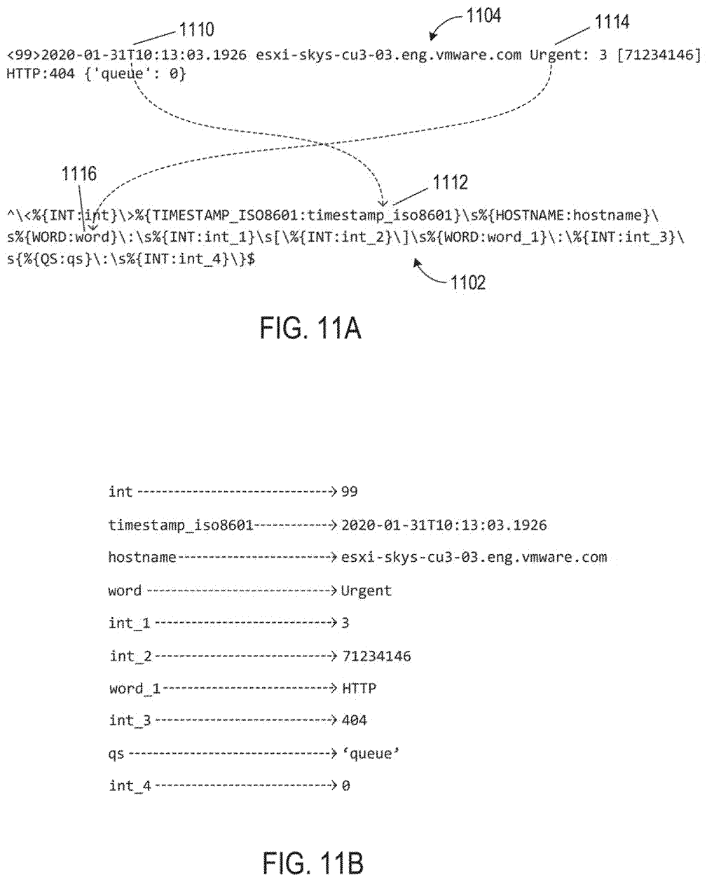

Grok expressions are formed from Grok patterns and may be used to parse character strings of log messages. FIGS. 11A-11B show an example of parsing a log message with a Grok expression. FIG. 11A shows an example of a Grok expression 1102 used to parse a log message 1104. Dashed directional arrows 1106 and 1108 represent assigning the time stamp 2019-07-31T10:13:03.1926 1110 in the log message 1104 to the variable identifier timestamp_iso8601 1112 and assigning the word Urgent 1114 in the log message 1104 to the variable identifier word 1116. FIG. 11B shows assignments of the strings in the log message 1104 to the variable identifiers of the Grok expression 1102.

Hash Code Generator

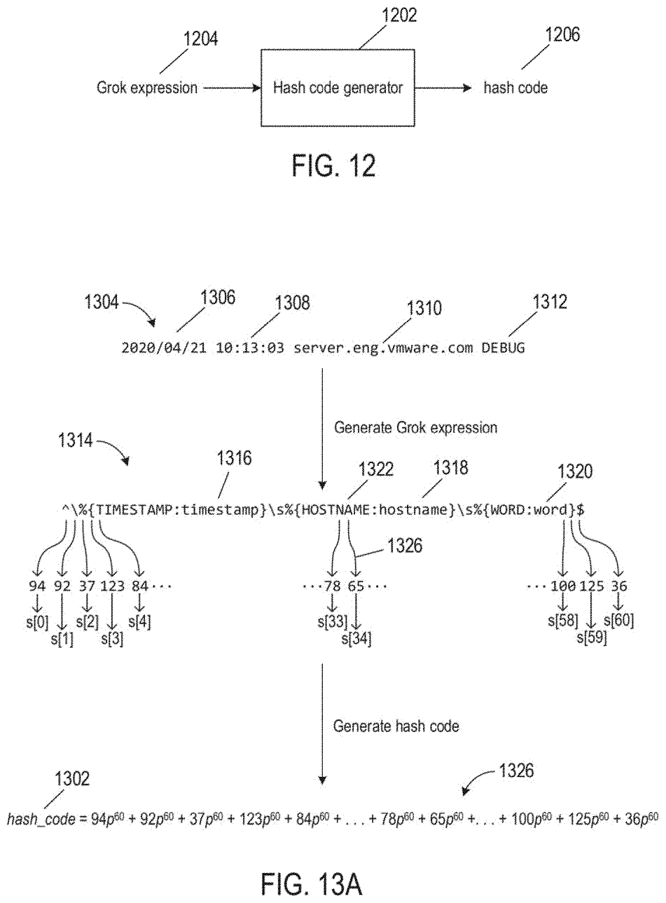

A Grok expression is a string of characters. Methods and systems generate a hash code for each Grok expression using a hash code generator. FIG. 12 shows an example of a hash code generator 1202 that receives as input a Grok expression 1204 associated with a log message, such as the Grok expression 1102, and generates as output a numerical value, called a “hash code.” The hash code generator 1202 uses a hash function to generate the hash code. An example of a hash function that may be used to generate a hash code for a Grok expression is given by

$$hashcode = {\sum }_{n = 0}^{N - 1} s [ n ] {p}^{n - 1} \qquad ( 1 )$$

where
s[n] is a coefficient that corresponds to the n-th character of the Grok expression;
N is the number of characters in the Grok expression; and
p is a prime number.
   Examples of suitable prime numbers for p include prime numbers greater than or equal to 31. The coefficients s[n] are code values in a numerical encoding of the characters of the Grok expression. The code values may be integers that represent upper- and lower-case alphabetical characters, numbers 0 through 9, and punctuation symbols. Examples of numerical encodings include, but are not limited to, standard numerical encoders, such as Unicode or ASCII (“American Standard Code for Information Interchange”). Other numerical encodings include user created encoders whereby code values are assigned to each upper- and lower-case alphabet character, each number 0 through 9, and each punctuation symbol.

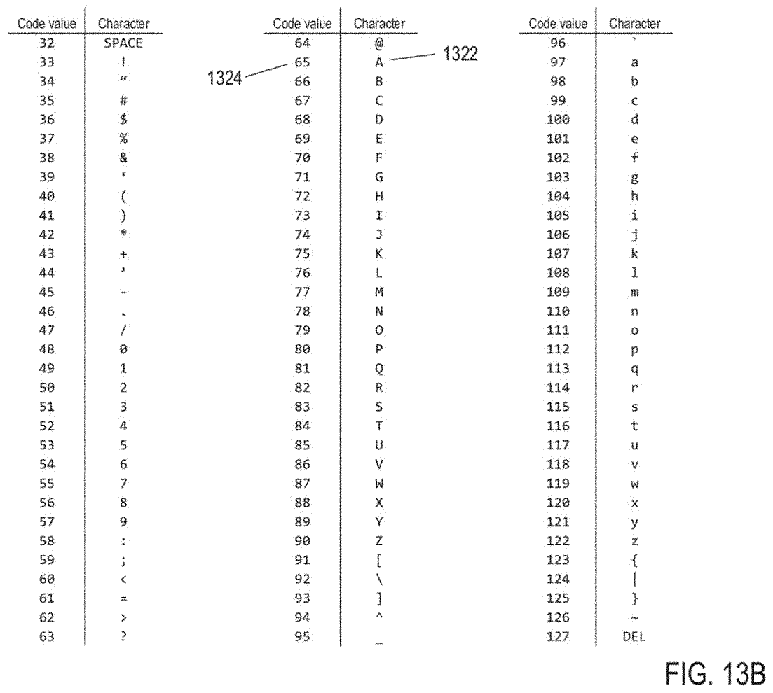

FIG. 13A shows an example of generating a hash code 1302 from a Grok expression of an example log message using the ASCII numerical encoding shown in FIG. 131. Example log message 1304 has a time stamp comprised of a date 1306 and time 1308 that indicate when the log message was generated by an event source. The log message 1304 includes a hostname 1310 of the event source that generated the log message and a word 1312 that expresses a message to be conveyed to a system administrator or an application owner. A Grok expression 1314 is generated for the log message 1304 as described above and comprises Grok patterns that correspond to the strings in the log message 1304. For example, the Grok expression 1314 may be used to assign variable identifier timestamp 1316 to the time stamp (i.e., date 1306 and time 1308), assign variable identifier hostname 1318 to the hostname 1310, and assign variable identifier word 1320 to the message. In this example, ASCII numerical encoding in FIG. 13B is used to assign a code value to each character in the Grok expression 1314. Each character in the Grok expression 1314 has an associated ASCII code value in FIG. 13B. For example, the character capital letter “A” 1322 in FIG. 13A has a code value “65” 1324 in FIG. 138. In FIG. 13A, the Grok expression 1314 comprises 61 characters. The coefficients of the hash function in Equation (1) are assigned the code values of the characters in the Grok expression 1314. Directional arrows, such as directional arrow 1328, identify a few of the ASCII code values assigned to certain characters in the Grok expression 1314. These code value assignments are found in FIG. 13B. Starting with the first character “\hat{ }” and ending with the character “$” of the Grok expression 1314, the code values assigned to the characters of the Grok expression 1314 are the coefficients in the hash function in Equation (1). For example, the first character “\hat{ }” in the Grok expression 1314 has a code value of “94” (See entry “\hat{ }” in table in FIG. 33B) and this code value is the coefficient s[0]=94. The thirty-fifth character “A” in the Grok expression 1314 has a code value of “65” and is the coefficient s[34]=65. The sixty-first character “$” in the Grok expression 1314 has a code value of “36” and this code value is the coefficient s[60]=36. FIG. 13A shows expanded an hash function 1326 for the Grok expression 1314 with code values of the characters as coefficients. A suitable prime number p is inserted into the hash function 1326 to give the hash code 1302.

The hash code generator generates the same hash code each time the same Grok expression is received as input. On the other hand, in certain instances, it may be the case that two or more Grok expressions determined from two or more entirely different and unrelated log messages have the same hash code. A circumstance where two or more Grok expressions obtained from different and unrelated log messages have the same hash code is called a “collision.”

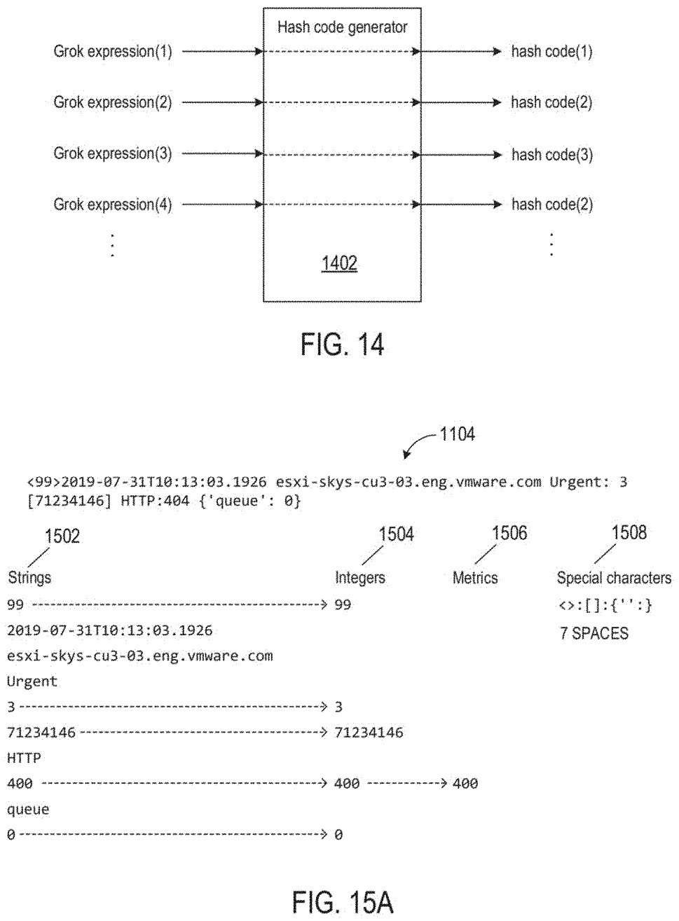

FIG. 14 shows an example of a collision. Block 1402 represents a hash code generator. Hash coder generator 1402 receives as input three different Grok expressions denoted by Grok expression(1), Grok expression(2), and Grok expression(3) as input and outputs three different corresponding hash codes denoted by hash code(1), hash code(2), and hash code(3). In this example, a collision results when the hash code generator 1402 outputs the hash code (2) in response to receiving a fourth Grok expression (4), which is different from the Grok expression(2).

Log Message Tags

A tag is a unique identifier that is used to identify log messages that belong to the same class of log messages. Tags may have 4, 5, 6, or more groups of letters and/or numbers separated by hyphens. Each group comprises randomly selected combinations of letters and numbers between 0 and 9. The groups of a tag may have the same number of characters. A tag having four groups with five letters and numbers per group is of the form xxxxx-xxxxx-xxxxx-xxxxx, where x represents a randomly selected letter or a randomly selected number between 0 and 9. For example, r14s7-80gb3-pj3w5-z631t is a tag having four groups with five characters per group. Alternatively, the groups of a tag may have different numbers of characters. A tag having five groups of different numbers of characters may be of the form xxxx-xxx-xxxxx-xxxxxx-xx. For example, t78w-pa6-5ocb2-xb90me is a tag having five groups with different numbers of characters per group. An example of a tag comprising four groups, each group having five randomly selected combinations of letters and numbers is 24f4g-35h3q-112pj-s87m7.

Log Message Metadata

Methods and systems generate metadata for each log message. Log-message metadata comprises one or more of the total number of strings, the total number of integers, the total number of special symbols, the total number of metrics, the total number of ignored variables, and any other content that can be counted. Special symbols are punctuation marks, such as colons, semicolons, parentheses, brackets, and spaces. Ignored variables are character symbols or letters of an alphabet of a language that is different from the language used to record the log message. For example, a log message conveyed in English may also includes Greek letters or Chinese symbols. The Greek letters and Chinese symbols would be considered Ignored variables.

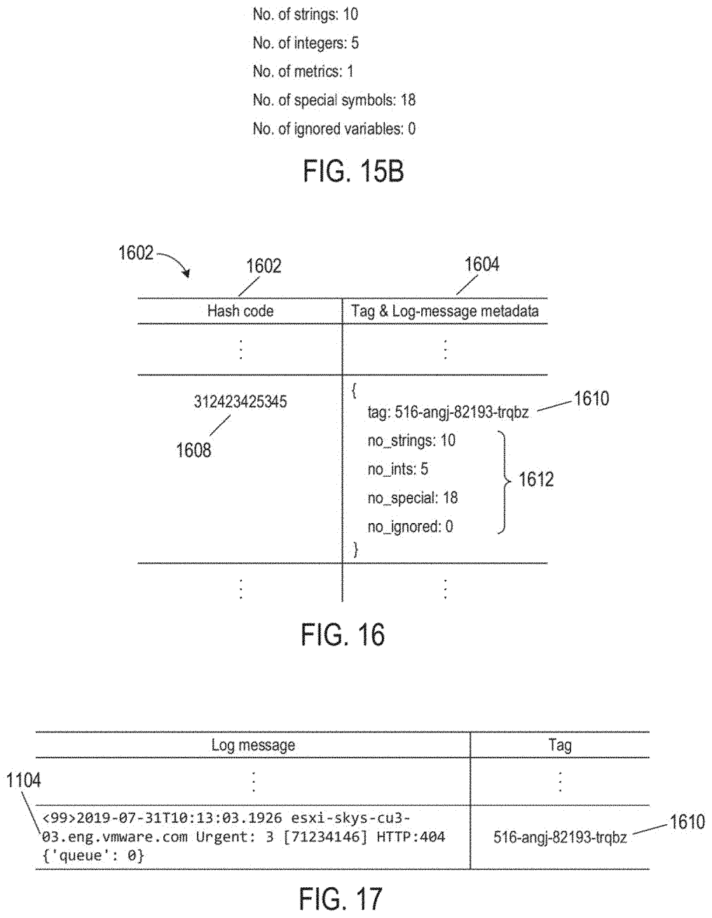

FIG. 15A shows an example of determining log-message metadata from the log message 1104 in FIG. 11. The log message 1104 contains a total of ten strings 1502. The ten strings 1502 contain five integers 1504. The five integers 1504 contain one metric 1506. The log message 1104 contains a total of eighteen special characters 1508. FIG. 15B shows an example of log-message metadata of the log message 1104. The log-message metadata comprises the total number of strings 10, total number of integers 5, total number of metrics 1, total number of special symbols 18, and total number of ignored variables 0.

A hash code table is formed from the hash codes of the Grok expressions, log-message metadata, and tags used to identify the classes the log messages belong to. Each entry in the hash table comprises a hash code obtained from a Grok expression of a log message, log-message metadata of the log message, and a tag used to identify the class of log messages the log message belongs to.

FIG. 16 shows an example hash table entry for the log message 1104 in a hash table 1602. The hash table 1602 comprises a column of hash codes 1604 and a column of tags and log-message metadata 1606. The hash table entry associated with the log message 1104 comprises an example hash code 1608 computed from the Grok expression 1102, a tag 1610 that identifies the class of log messages the log message 1104 belongs to, and log-message metadata 1612. In this example, elements of the log-message metadata are the total number of strings 10, total number of integers 5, total number of special symbols 18, total number of ignored variables 0. Note that in this example the total number of metrics has been omitted from the elements of metadata in the hash table entry.

The tag 1610 used to identify the class of log messages the log message 1104 belongs to is added to the log message 1104 in a log file. FIG. 17 shows an example entry of a log file 1702 with the log message 1104 tagged with the tag 1610.

Tagging Log Messages

In order to ensure that each log message received by the log management server 642 is accurately classified, methods and systems address three different circumstances for tagging log messages and/or creating hash table entries for new classes of log messages. For each log message received by the log management server, a Grok expression is generated, a hash code is generated from the Grok expression, and log-message metadata is determined from the log message as described above. The three different circumstances for classifying the log message are (1) the hash code and the log-message metadata are already recorded in a hash table entry of the hash table, (2) the hash code does not match any of the hash codes of the hash table, and (3) the hash code matches a hash code of a hash table entry (i.e., a collision) but elements of the log-message metadata do not match all elements of log-message metadata in the hash table entry. Methods and system address each of these three circumstances as follows:

(1) If the hash code of the Grok expression matches a hash code of a hash table entry, elements of log-message metadata of the log-message are compared with elements of log-message metadata in the hash table entry. If elements of the log-message metadata match all of the elements of the log-message metadata in the hash table entry, the log message is tagged with the tag of the hash table entry. In other words, the log message belongs the class of log messages associated with the hash table entry.

(2) If the hash code of the Grok expression does not match any of the hash codes in the hash table, a new hash table entry is created by adding the hash code and the log-message metadata of the log message to the hash table. A tag is generated for the log message as described above. The tag is added to the hash table entry as described above with reference to FIG. 16 and the tag is added to the log message in a log file as described above with reference to FIG. 17. In this case, the log message is the first log message in a newly discovered class of log messages and the tag is used to tag subsequent log messages as described in circumstance (1).

(3) Consider the case where the hash code of the Grok expression matches a hash code of a hash table entry, but one or more elements of the log-message metadata does not match any of the elements of the log-message metadata in the hash table entry. In this circumstance, a hash code collision has occurred as described above with reference to FIG. 14. Methods and systems generate a new tag, the log message is tagged with the new tag as described above with reference to FIG. 17, and the tag and the log-message metadata added to the hash table entry. As a result, the hash table entry comprises the hash code and two sets of log-message metadata and corresponding tags and may be used to classify two different types of log messages. When a subsequence log message is received by the log management server, a Grok expression is generated, a hash code is generated from the Grok expression, and log-message metadata of the log message is determined. If the hash code matches the hash code of the hash table entry and elements of the log-message metadata matches all of the elements of one of the two sets of log-message metadata, the log message is tagged with the tag of the matching log-message metadata. If one or more elements of the log-message metadata fails to match all of the elements of the two sets of log-message metadata, methods and systems generate a new tag, the log message is tagged with the new tag, and the tag and the log-message metadata are added to the hash table entry. The hash table entry comprises the hash code and three sets of log-message metadata and corresponding tags and may be used to classify three different types of log messages.

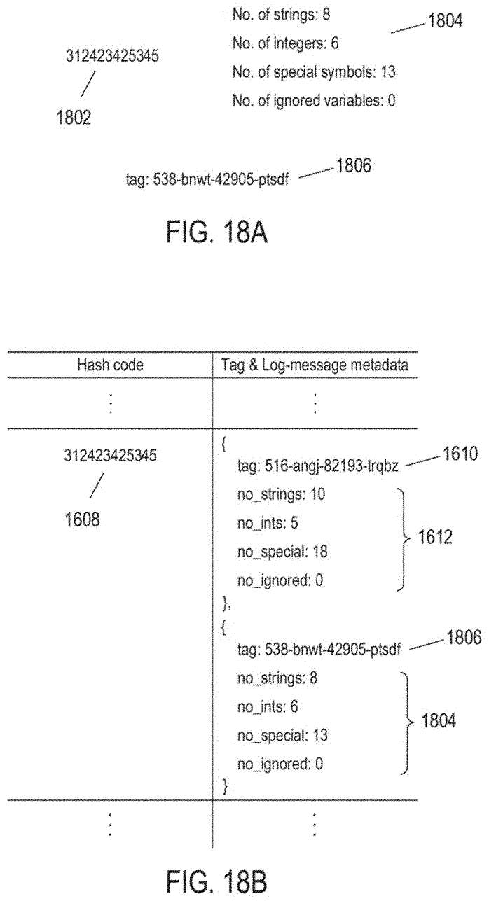

FIGS. 18A-18B show an example of adding log-message metadata to a hash table entry of a hash table as a result of a hash code collision. FIG. 18A shows a hash code 1802 obtained from a Grok expression of a log message and log-message metadata 1804 of the log message. In this example, the log-message metadata 1804 comprises a total number of strings 8, total number of integers 6, total number of special symbols 13, and total number of ignored variables 0. Although, the hash code 1802 is identical to the hash code 1608 in FIG. 16, elements of the log-message metadata 1804 do match the elements of the log-message metadata 1612. As a result, the log message with the hash code 1802 is not of the same class as the log message 1104. A new class is created for the log message by generating a new tag 1806. The log message is tagged with the new tag 1806. The new tag 1806 and log-message metadata 1804 are added to the hash table entry as shown in FIG. 18B. When a subsequent log message is received, a Grok expression is generated, a hash code is generated from the Grok expression, and log-message metadata of the subsequent log message is determined. If the hash code matches the hash code 1608 of the hash table entry and all elements of the log-message metadata match all elements of the log-message metadata 1612, the subsequent log message is tagged with the tag 1610. On the other hand, if all elements of the log-message metadata match all elements of the log-message metadata 1804, the subsequently generated log message is tagged with the tag 1806.

The resulting classification of log messages may be used in troubleshooting and in RCA. For example, one class of log messages may contain log messages that describe errors. While another class of log message may contain log messages that describe warnings. Still other classes of log message may contain metrics, such as HTTP codes, that can be extracted using the Grok expression that corresponds to the log messages in the same class. For example, Grok expression 1102 parses the log message 1104, as shown in FIG. 11B. The HTTP code 404 is a metric that describes the state of the event source at the time log message 1104 was generated (e.g., HTTP code 404 represents file or page not found). The Grok expression 1102 may be used to extract HTTP codes (i.e., extract metrics) from other log messages in the same class. The extracted HTTP codes may be used to monitor the state of event sources that generate log messages in the same class and determine when a particular problem started, such as the problem of file not found.

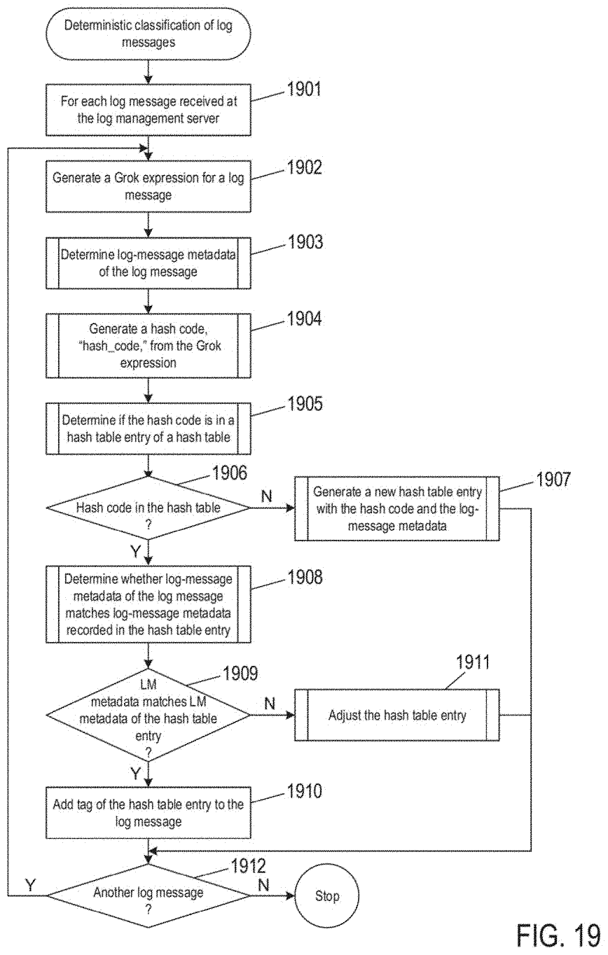

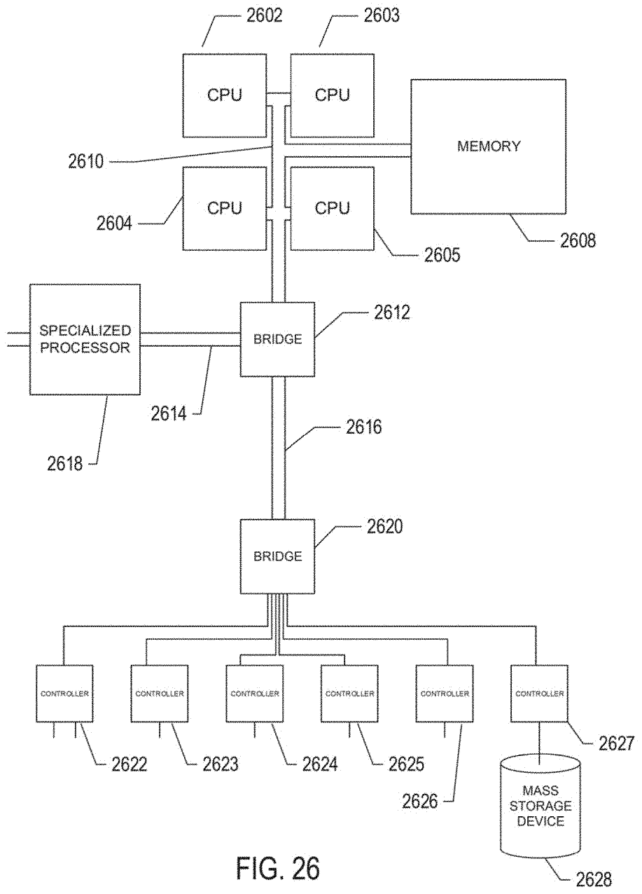

The methods described below with reference to FIGS. 19-25 are stored in one or more data-storage devices as machine-readable instructions and are executed by one or more processors of the computer system shown in FIG. 26.

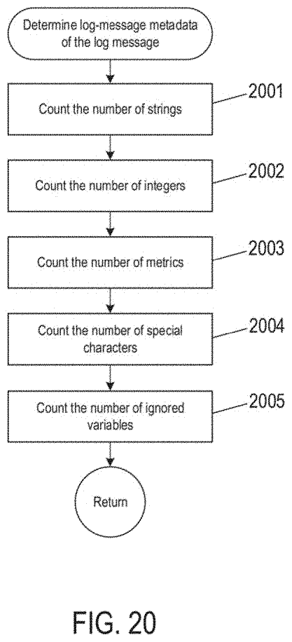

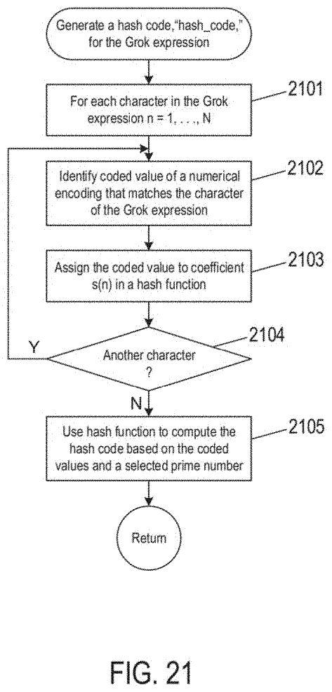

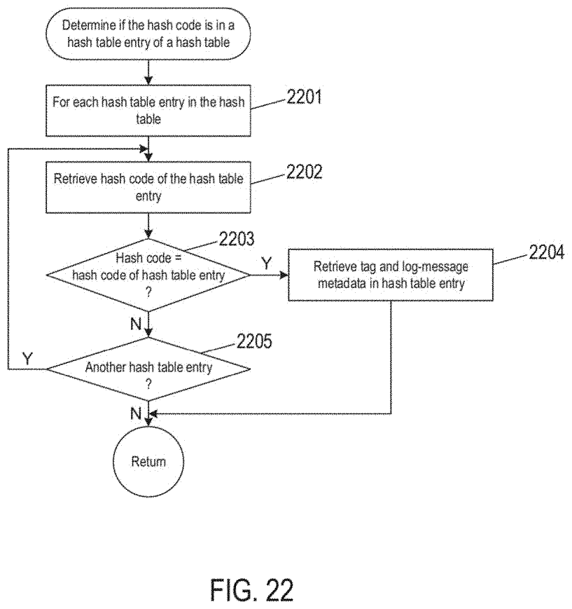

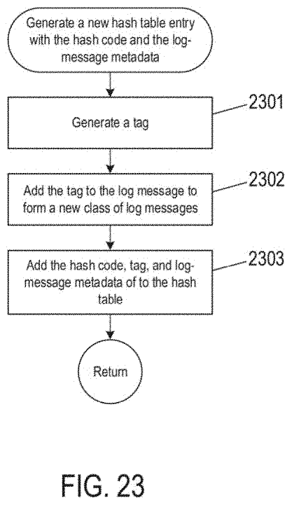

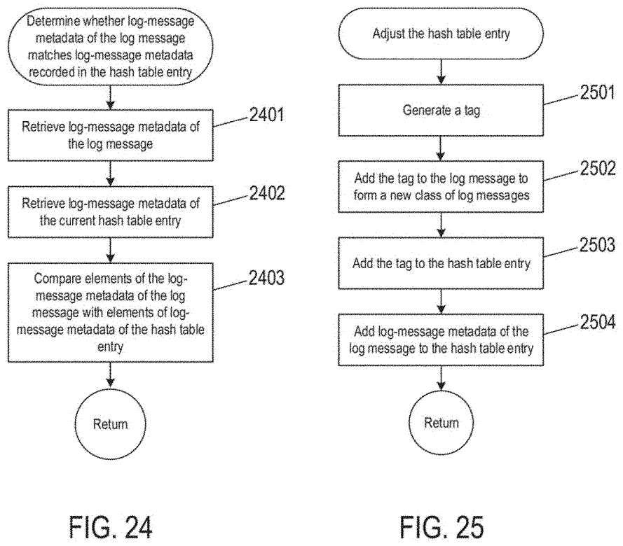

FIG. 19 is a flow diagram deterministic classification of log messages. A loop beginning with block 1901 repeats the computation operations represented by blocks 1902-1910 for each log message received by log management server. In block 1902, a Grok expression is generated for a log message as described above with reference to FIGS. 9 and 10. In block 1903, a “determine log-message metadata of the log message” procedure is performed. An example implementation of the “determine log-message metadata of the log message” procedure is described below with reference to FIG. 20. In block 1904, a “generate a hash code, “hash_code” from the Grok expression” procedure is performed. An example implementation of the “generate a hash code, “hash_code” from the Grok expression” procedure is described below with reference to FIG. 21. In block 1905, a “determine if the hash code is in a hash table entry of a hash table” procedure is performed. An example implementation of the “determine if the hash code is in a hash table entry of a hash table” procedure is described below with reference to FIG. 22. In decision block 1906, when the hash code determined in block 1904 matches the hash code of a hash table entry in the hash table, control flow to block 1908. Otherwise, when the hash code determined in block 1904 does not match any of the hash codes in the hash table, control flow to block 1907. In block 1907, a “generate a new hash table entry with the hash code and the log-message metadata” procedure is performed. An example implementation of the “generate a new hash table entry with the hash code and the log-message metadata” procedure is described below with reference to FIG. 23. In block 1908, a “determine whether log-message metadata of the log message matches log-message metadata recorded in the hash table entry” procedure is performed. An example implementation of the “determine if the hash code is in a hash table entry of a hash table” procedure is described below with reference to FIG. 24. In decision block 1909, when all elements of the log-message metadata determined in block 1903 match the elements of the log-message metadata in the hash table entry, control flows to block 1910. Otherwise, when the elements of the log-message metadata determined in block 1903 fails to match the elements of the log-message metadata in the hash table entry, control flows to block 1911. In block 1910, a tag in the hash table entry is added to the log message in a log file as described above with reference to FIG. 17. In block 1911, a “adjust the hash table entry” procedure is performed. An example implementation of the “adjust the hash table entry” procedure is described below with reference to FIG. 25. In decision block 1912, the operations represented by blocks 1902-1910 are repeated for another log message.

FIG. 20 is a flow diagram illustrating an example implementation of the “determine log-message metadata of the log message” procedure performed in block 1903. In block 2001, the number of strings in the log message are counted. In block 2002, the number of integers in the log message are counted. In block 2003, the number of metrics in the log message are counted. In block 2004, the number of special characters in the log message are counted. In block 2005, the number of ignored variables in the log message are counted.

FIG. 21 is a flow diagram illustrating an example implementation of the “generate a hash code, “hash_code” from the Grok expression procedure” procedure performed in block 1904. A loop beginning with block 2101 repeats the computational operations represented by blocks 2102 and 2103 for each character of the Grok expression. In block 2102, code value of a numerical encoding that matches the character in the Grok expression is identified as described above with reference to FIG. 13A. In block 2103, the coded value is assigned to a coefficient of a hash function as described above with reference to FIG. 13A. In decision block 2104, blocks 2102 and 2103 are repeated for another character in the Grok expression. In block 2105, the hash function is used to compute the hash code for the Grok expression based on the coded values and a selected prime number as described above with reference to Equation (1).

FIG. 22 is a flow diagram illustrating an example implementation of the “determine if the hash code is in a hash table entry of a hash table” procedure performed in block 1905. A loop beginning with block 2201 repeats the computational operation represented by block 2202 until a hash table entry of a hash table is found. In block 2202, a hash code of the hash table entry is retrieved from the hash table. In decision block 2203, when the hash code of the Grok expression equals the hash code of the hash table entry, control flows to block 2204. Otherwise, control flows to block 2205. In block 2204, a tag and log-message metadata recorded in the hash table entry are retrieved. In decision block 2205, the operations represented by blocks 2202-2204 are repeated for another hash table entry of the hash table.

FIG. 23 is a flow diagram illustrating an example implementation of the “generate a new hash table entry with the hash code and the log-message metadata” procedure performed in block 1907. In block 2301, a tag is generated. In block 2302, the tag is added to the log message in a log file and a new class of log messages is formed. In block 2303, the hash code of the Grok expression, the tag, and the log-message metadata are added to the hash table.

FIG. 24 is a flow diagram illustrating an example implementation of the “determine whether log-message metadata of the log message matches log-message metadata recorded in the hash table entry” procedure performed in block 1908. In block 2401, log-message metadata of the log message are retrieved. In block 2402, log-message metadata of the hash table entry are retrieved. In block 2403, elements of the log-message metadata of the log message are compared with elements of the log-message metadata of the hash table entry.

FIG. 25 is a flow diagram illustrating an example implementation of the “adjust the hash table entry” procedure performed in block 1911. In block 2501, a tag is generated. In block 2502, the tag is added to the log message in a log file and a new class of log messages is formed. In block 2503, the tag is added to hash table entry of the hash table. In block 2504, the log-message metadata of the log message is added to hash table entry of the hash table.

FIG. 26 shows an example of a computer system that executes a log management server for generating a Grok expression graph, a Grok expression, and for extracting a metric from a stream of log messages described above. The internal components of many small, mid-sized, and large computer systems as well as specialized processor-based storage systems can be described with respect to this generalized architecture, although each system may feature many additional components, subsystems, and similar, parallel systems with architectures similar to this generalized architecture. Computers that receive, process, and store log messages may be described by the general architectural diagram shown in FIG. 26, for example. The computer system contains one or multiple central processing units (“CPUs”) 2602-2605, one or more electronic memories 2608 interconnected with the CPUs by a CPU/memory-subsystem bus 2610 or multiple busses, a first bridge 2612 that interconnects the CPU/memory-subsystem bus 2610 with additional busses 2614 and 2616, or other types of high-speed interconnection media, including multiple, high-speed serial interconnects. These busses or serial interconnections, in turn, connect the CPUs and memory with specialized processors, such as a graphics processor, and with one or more additional bridges 2620, which are interconnected with high-speed serial links or with multiple controllers 2622-2627, such as controller 2627, that provide access to various different types of mass-storage devices 2628, electronic displays, input devices, and other such components, subcomponents, and computational devices. It should be noted that computer-readable data-storage devices include optical and electromagnetic disks, electronic memories, and other physical data-storage devices.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method stored in one or more data-storage devices and executed using one or more processors of a computer system for classifying log messages generated by event sources in a distributed computing system, the method comprising:
generating a Grok expression for a log message;
determining log-message metadata of the log message; and
classifying the log message based on the Grok expression and the log-message metadata.

2. The method of claim 1 wherein determining the log-message metadata comprises counting one or more of a number of strings in the log message, a number of integers in the log message, a number of metrics in the log message, a number of special characters in the log message, and a number of ignored variables in the log message.

3. The method of claim 1 wherein classifying the log message comprises:
generating a hash code from the Grok expression;
determine if the hash code matches a hash code in a hash table entry of a hash table; and
when the hash code does not match any hash codes in the hash table,
generating a tag that identifies a class the log message belongs to,
assigning the tag to the log message,
recording the log message and tag in a log file, and
generating a new hash table entry with the hash code, the tag, and the log-message metadata.

4. The method of claim 1 wherein classifying the log message comprises:
generating a hash code from the Grok expression;
determine if the hash code matches a hash code in a hash table entry of a hash table; and
when the hash code matches the hash code of the hash table entry,
determining if the log-message metadata of the log message matches log-message metadata recorded in the hash table entry,
when the log-message metadata of the log message matches the log-message metadata recorded in the hash table entry,
assigning a tag already recorded in the hash table entry to the log message, the tag identifying a class the log message belongs to, and
recording the log message and tag in a log file.

5. The method of claim 1 wherein classifying the log message comprises:
generating a hash code from the Grok expression;
determine if the hash code matches a hash code in a hash table entry of a hash table; and
when the hash code matches the hash code of the hash table entry,
determining if the log-message metadata of the log message matches log-message metadata recorded in the hash table entry,
when the log-message metadata of the log message does not match the log-message metadata recorded in the hash table entry,
generating a tag that identifies a class the log message belongs to,
assigning the tag to the log message,
recording the log message and tag in a log file, and
adding the tag and the log-message metadata of the log message to the hash table entry.

6. The method of claim 1 wherein classifying the log message comprises:
generating a hash code from the Grok expression;
when the hash code matches a hash code of a hash table entry in a hash table, retrieving log-message metadata of the hash table entry, comparing elements of the log-message metadata of log message to elements of the log-message metadata of the hash table entry;
when the elements of the log-message metadata of the log message match the elements of the log-message metadata of the hash table entry, assigning a tag already recorded in the hash table entry to the log message, the tag identifying a class the log message belongs to; and
when one or more elements of the log-message metadata of the log message do not match the elements of the log-message metadata of the hash table entry,
generating a tag that identifies a class the log message belongs to,
assigning the tag to the log message, and
adjusting the hash table entry to include the tag and the log-message metadata of the log message.

7. The method of claim 1 further comprising using classified log messages to perform troubleshooting and root cause analysis of the event sources.

8. A computer system for classifying log messages generated by event sources in a distributed computing system, the system comprising:
one or more processors;
one or more data-storage devices; and
machine-readable instructions stored in the one or more data-storage devices that when executed using the one or more processors controls the system to perform operations comprising:
for each log message generated by the event sources,
generating a Grok expression for a log message,
determining log-message metadata of the log message, and
determining a class of the log message based on the Grok expression and the log-message metadata; and
displaying a representative log message of each class of the log messages in a graphical user interface.

9. The system of claim 8 wherein determining the log-message metadata comprises counting one or more of a number of strings in the log message, a number of integers in the log message, a number of metrics in the log message, a number of special characters in the log message, and a number of ignored variables in the log message.

10. The system of claim 8 wherein determining the class of the log message comprises:
generating a hash code from the Grok expression;
determine if the hash code matches a hash code in a hash table entry of a hash table; and
when the hash code does not match any hash codes in the hash table,
generating a tag that identifies a class the log message belongs to,
assigning the tag to the log message,
recording the log message and tag in a log file, and
generating a new hash table entry with the hash code, the tag, and the log-message metadata.

11. The system of claim 8 wherein determining the class of the log message comprises:
generating a hash code from the Grok expression;
determine if the hash code matches a hash code in a hash table entry of a hash table; and
when the hash code matches the hash code of the hash table entry,
determining if the log-message metadata of the log message matches log-message metadata recorded in the hash table entry,
when the log-message metadata of the log message matches the log-message metadata recorded in the hash table entry,
assigning a tag already recorded in the hash table entry to the log message, the tag identifying a class the log message belongs to, and
recording the log message and tag in a log file.

12. The system of claim 8 wherein determining the class of the log message comprises:
generating a hash code from the Grok expression;
determine if the hash code matches a hash code in a hash table entry of a hash table; and
when the hash code matches the hash code of the hash table entry,
determining if the log-message metadata of the log message matches log-message metadata recorded in the hash table entry,
when the log-message metadata of the log message does not match the log-message metadata recorded in the hash table entry,
generating a tag that identifies a class the log message belongs to,
assigning the tag to the log message,
recording the log message and tag in a log file, and
adding the tag and the log-message metadata of the log message to the hash table entry.

13. The system of claim 8 wherein determining the class of the log message comprises:
generating a hash code from the Grok expression;
when the hash code matches a hash code of a hash table entry in a hash table, retrieving log-message metadata of the hash table entry, comparing elements of the log-message metadata of log message to elements of the log-message metadata of the hash table entry;
when the elements of the log-message metadata of the log message match the elements of the log-message metadata of the hash table entry, assigning a tag already recorded in the hash table entry to the log message, the tag identifying a class the log message belongs to; and
when one or more elements of the log-message metadata of the log message do not match the elements of the log-message metadata of the hash table entry,
generating a tag that identifies a class the log message belongs to,
assigning the tag to the log message, and
adjusting the hash table entry to include the tag and the log-message metadata of the log message.

14. The system of claim 8 further comprising using one or more classes of log messages to perform troubleshooting and root cause analysis of the event sources.

15. A non-transitory computer-readable medium encoded with machine-readable instructions that implement a method carried out by one or more processors of a computer system to perform operations comprising:
for each log message received by the computer system,
generating a Grok expression for a log message,
determining log-message metadata of the log message, and
classifying the log message based on the Grok expression and the log-message metadata.

16. The medium of claim 15 wherein determining the log-message metadata comprises counting one or more of a number of strings in the log message, a number of integers in the log message, a number of metrics in the log message, a number of special characters in the log message, and a number of ignored variables in the log message.

17. The medium of claim 15 wherein classifying the log message comprises:
generating a hash code from the Grok expression;
determine if the hash code matches a hash code in a hash table entry of a hash table; and
when the hash code does not match any hash codes in the hash table,
generating a tag that identifies a class the log message belongs to,
assigning the tag to the log message,
recording the log message and tag in a log file, and
generating a new hash table entry with the hash code, the tag, and the log-message metadata.

18. The medium of claim 15 wherein classifying the log message comprises:
generating a hash code from the Grok expression;
determine if the hash code matches a hash code in a hash table entry of a hash table; and
when the hash code matches the hash code of the hash table entry,
determining if the log-message metadata of the log message matches log-message metadata recorded in the hash table entry,
when the log-message metadata of the log message matches the log-message metadata recorded in the hash table entry,
assigning a tag already recorded in the hash table entry to the log message, the tag identifying a class the log message belongs to, and
recording the log message and tag in a log file.

19. The medium of claim 15 wherein classifying the log message comprises:
generating a hash code from the Grok expression;
determine if the hash code matches a hash code in a hash table entry of a hash table; and
when the hash code matches the hash code of the hash table entry,
determining if the log-message metadata of the log message matches log-message metadata recorded in the hash table entry,
when the log-message metadata of the log message does not match the log-message metadata recorded in the hash table entry,
generating a tag that identifies a class the log message belongs to,
assigning the tag to the log message,
recording the log message and tag in a log file, and
adding the tag and the log-message metadata of the log message to the hash table entry.

20. The medium of claim 15 wherein classifying the log message comprises:
generating a hash code from the Grok expression;
when the hash code matches a hash code of a hash table entry in a hash table, retrieving log-message metadata of the hash table entry, comparing elements of the log-message metadata of log message to elements of the log-message metadata of the hash table entry;
when the elements of the log-message metadata of the log message match the elements of the log-message metadata of the hash table entry, assigning a tag already recorded in the hash table entry to the log message, the tag identifying a class the log message belongs to; and
when one or more elements of the log-message metadata of the log message do not match the elements of the log-message metadata of the hash table entry,
generating a tag that identities a class the log message belongs to,
assigning the tag to the log message, and
adjusting the hash table entry to include the tag and the log-message metadata of the log message.

21. The medium of claim 15 further comprising using classified log messages to perform troubleshooting and root cause analysis of the event sources.
